(19) United States
(12) Patent Application Publication
(10) Pub. No.: US 2004/0058635 A1
(43) Pub. Date: Mar. 25, 2004

(54) Apparatus and method for deboning slaughtered animals

(76) Inventor: Timothy Andrew Budd, Northgate (AU)

Correspondence Address: TIMOTHY ANDREW BUDD, 18 COULTER CRESCENT, NORTHGATE, QUEENSLAND, 4013, AU

(21) Appl. No.: 10/406,200

(22) Filed: Apr. 4, 2003

(30) Foreign Application Priority Data
Sep. 20, 2002 (AU) 200 230 1085

(51) Int. Cl. A22C 17/02; A22C 17/04; A22C 17/06

(52) U.S. Cl. 452/137

(57) ABSTRACT

Apparatus for removing the pelvic bone from a slaughtered animal carcass which has been split longitudinally, comprising an elongated arm, fulcrum means at one end of the arm for location against the carcass and engagement means intermediate the ends of the arm for engaging the pelvic bone adjacent the ischium thereof, whereby in use a force applied to the other end of said arm causes by a levering action about the fulcrum means, removal of the pelvic bone from the carcass.

### FIELD OF INVENTION

THIS INVENTION relates to an apparatus and method for deboning slaughtered animals and in particular a method and apparatus for removing the pelvic bone from slaughtered beef carcasses.

### BACKGROUND ART

In the processing of slaughtered beef carcases, the carcass is normally initially suspended from an elevated hook or the like which may be on a conveyor rail and the carcass is split longitudinally into two halves. Various deboning operations are then carried out to remove selected bones from the carcass. One of the common operations undertaken is the removal of the split pelvic bone. This task may be undertaken with the aid of a hook which is inserted into the large aperture in the pelvic bone known as the obturator foramen or “pop-eye” and a pulling force applied to the hook to extract the bone from the carcass. Alternatively, a simple direct manual operation is employed with the hands or fingers inserted into the aperture to grip the bone and enable the bone to be pulled out. Both the above procedures are manual operations and are relatively time consuming due to the nature of the task requiring direct application of a manual pulling force. Further, the considerable manual force required to be applied by the butcher or other worker often results in muscle or joint injuries to the worker. The worker can also be injured if the hook or his fingers or hands become unintentionally detached from the “pop-eye”.

The present invention aims to overcome or at least alleviate the above disadvantages by providing an apparatus and method for deboning animal carcasses which will reduce the possibility of injury to the worker and which will result in more efficient processing operations. Other objects and advantages of the invention may become apparent from the following description.

### DISCLOSURE OF THE INVENTION

The present invention thus provides in a first aspect apparatus for removing the pelvic bone of the carcass of a slaughtered animal such as a cattle carcass which has been split longitudinally, said apparatus comprising an elongated arm, fulcrum means at one end of said arm for location against said carcass and engagement means intermediate the ends of said arm for engaging the pelvic bone adjacent the ischium thereof, whereby in use a force applied to the other end of said arm causes by a levering action about said fulcrum means, removal of said pelvic bone from said carcass.

The elongated arm may be of linear form however preferably the elongated arm is of arcuate form along its length. Preferably, the engagement means comprises means adapted for location within the obturator foramen of the pelvic bone to engage the ischium. Suitably, the engagement means is in the form of a hook which is directed towards the other end of the arm Preferably, where the elongated arm is of arcuate form, the hook or other engagement means is located on the convex side of the arm. The hook or other engagement means is also suitably located within the plane or planes of the convexity of the arm. The hook may be secured to the arm by for example welding or alternatively the hook may be formed integrally with the arm for example by slitting a section of the arm at the desired location of the hook and deforming the section out of the plane of the arm to define the hook.

Preferably, the fulcrum means includes means to spread the load applied thereto when a force is applied to the other end of the arm to extract the pelvic bone. Such means may be in the form of a plate which lies in a plane extending transversely of the arm. Preferably, the plate is angled acutely to the arm on the side of the arm containing the hook or other engagement means.

In one arrangement, the fulcrum plate may be hingedly mounted to the arm for movement about an axis extending transversely of and suitably normal to the longitudinal axis of the arm. Biasing means may be provided to normally bias the plate to a position where it is juxtaposed with the arm on the side of the arm containing the engagement means or hook. The fulcrum plate however may be moved against the bias away from the juxtaposed position about the hinge axis for engaging the carcass in use. The hinge axis of the fulcrum plate in this embodiment also defines a pivot axis of the arm to facilitate levering movement of the arm during pulling of the pelvic bone from the carcass.

Preferably, the other end of the arm includes gripping means to facilitate the application of a levering force to the arm. Most preferably, the gripping means comprises a handle which extends transversely of the arm The handle may suitably be of tubular form in cross section and most preferably extends substantially normal to the axis of the arm and equidistantly on opposite sides of the arm. The handle may be attached to the arm for example by welding or alternatively the arm and handle may be formed in one piece for example by being stamped from sheet metal.

Preferably the arm and other components of the apparatus are constructed of stainless steel however they may be constructed of other materials.

The present invention in a further aspect provides a method of removing the pelvic bone of the carcass of a slaughtered animal such as a beef cattle carcass which has been split longitudinally, said method including the steps of engaging the ischium of the pelvic bone through the obturator foramen of said pelvic bone with an intermediate portion of lever arm means and levering said pelvic bone from said carcass with said lever arm means.

Preferably, the method includes the step of engaging a fulcrum end of the lever arm means with the carcass to effect the levering action. Preferably, the levering of the pelvic bone is effected by application of a force to said lever arm means remote from the location of engagement of the ischium by the lever arm means in the manner of a second order lever.

### BRIEF DESCRIPTION OF THE DRAWINGS

In order that the invention may be more readily understood and put into practical effect, reference will now be made to the accompanying drawings which illustrate preferred embodiments of the invention and wherein:

FIG. 1 illustrates in perspective view, deboning apparatus according to the present invention;

FIG. 2 is a side view of the apparatus of FIG. 1;

FIG. 3 illustrates diagrammatically a portion of the animal carcass and the manner in which the apparatus of the invention is used; and

FIG. 4 illustrates in side view an alternative deboning apparatus according to the present invention.

### DETAILED DESCRIPTION OF THE DRAWINGS

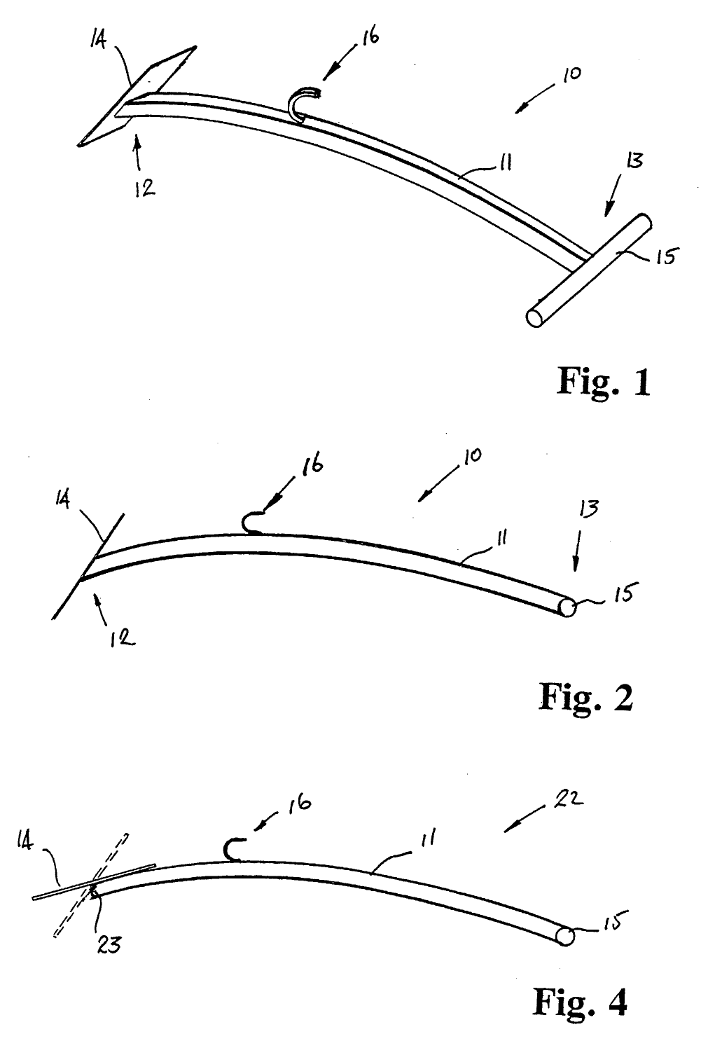

Referring to the drawings and firstly to FIGS. 1 and 2, there is illustrated deboning apparatus 10 according to the present invention comprising an elongated lever arm 11 which is of arcuate form longitudinally and which has a fulcrum end 12 and a operating end 13. Typically, the arm 11 has a rectangular cross section with a width substantially less than the depth of the arm 11. Typically, the arm 11 in cross section may have a width in the range of 4 mm to 7 mm and a depth of 20 mm to 30 mm. An abutment plate 14 is fixed rigidly to the arm 11 at the fulcrum end 12 thereof to extend transversely of the arm 11 and equidistantly on opposite sides thereof. The plate 14 as more clearly illustrated in FIG. 2 is arranged at an acute angle to the convex side of the arm 11. Typically, the arm 11 has a width of approximately 25 mm and a depth of approximately 50 mm. These dimensions however may be varied.

At the operating end 13 of the arm 11, a gripping handle 15 is provided, the gripping handle 15 being of tubular form in cross section and being rigidly fixed to the arm 11 to extend substantially normal to the arm 11 and equidistantly on opposite sides thereof. Typically, the arm is approximately 110 mm long with a diameter of 25 mm.

Provided intermediate the ends 12 and 13 of the arm 11 and on the convex side thereof is a curved hook 16 which lies in the same plane as the arm 11 and faces towards the operating end 13 of the arm 11. Preferably, the hook 16 is located closer to the fulcrum end 12 of the arm 11 to increase the mechanical advantage as described further below. Most suitably, the hook 16 is positioned along the arm 11 such that its distance from the operating end 13 is approximately twice its distance from the fulcrum end 13. Typically, the hook 16 may extend approximately 25 mm to 35 mm from the arm 11.

In use and as shown in FIG. 3, a carcass 17 of an animal to be deboned, usually beef cattle, is hung from an elevated position and split longitudinally along the spine 18 by a suitable severing tool which also splits the pelvic bone 19. The apparatus 10 is then positioned such that the hook 16 locates within the obturator foramen 20 and locates against the ischium 21 of the pelvic bone 19 whilst the fulcrum plate 14 is located on the inside of the carcass 17 against the flesh of the carcass 17. The handle 15 is then gripped by the butcher or user and a force applied thereto to pivot the arm 11 about the fulcrum plate 14 in a direction away from the pelvic bone 19. The mechanical advantage achieved by the position of the hook 16 along the arm 11 enables a high force to be applied directly to the pelvic bone 19 at the ischium 21 to pull and strip the pelvic bone 19 from the carcass 17. The carcass 17 may then be further deboned or butchered in the normal manner.

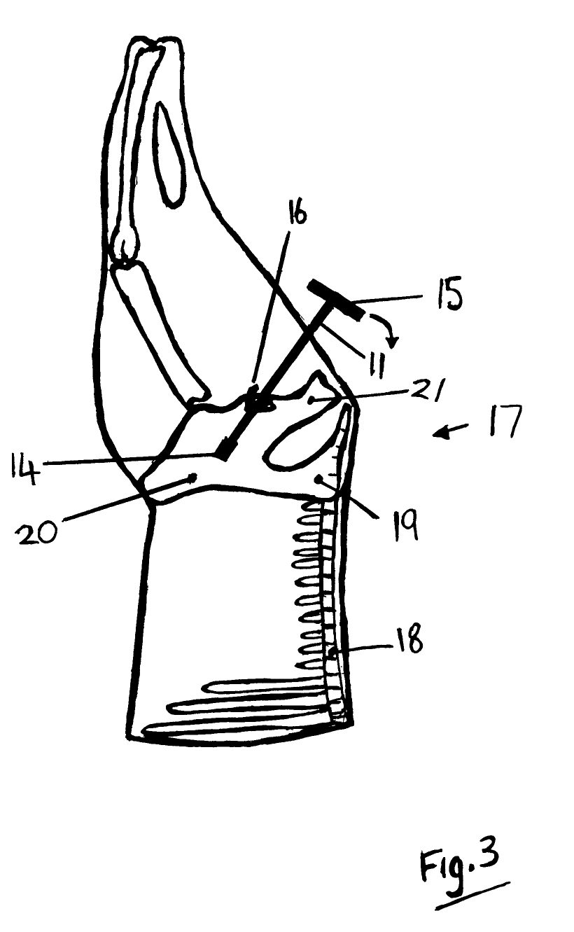

Referring now to FIG. 4, the alternative deboning apparatus 22 is of similar form the apparatus of FIGS. 1 and 2 and in which like components have been given like numerals. In this embodiment however, the plate 14 is hingedly mounted to the arm 11 at 23 for movement about a hinge axis extending substantially normal to the arm 11. In addition biasing means are provided to normally bias the plate 14 against the arm 11 on the convex side thereof. The biasing means typically may be in the form of a spring associated with the hinge connection 23. The plate 14 however is capable of pivoting movement against the bias about the hinge axis as shown in dotted outline.

The apparatus 22 is used in a similar manner to that described above with reference to the apparatus 10 however in this case, the plate 14 can adjust its pivotal position to match the surface against which it sits. Further, the hinge axis defined by the hinge connection 23 defines a fulcrum axis about which the arm 11 is pivoted during extraction of the pelvic bone 19.

Whilst the arm 11 is shown to be of a curved form to more readily facilitate it use, it may be of linear form. Further the hook 16 may be of any configuration or may be of an alternative form to enable engagement with the pelvic bone in the manner described. The handle 15 may also be omitted in some embodiments with the force being applied to the arm simply by gripping portion of the arm adjacent the end 13.

Although the invention has been described with reference to one or more specific examples, it will be appreciated by those skilled in the art that the invention may be embodied in other forms which fall within the broad scope and ambit of the invention as defined by the following claims.

The claims defining the invention are as follows:

1. Apparatus for removing the pelvic bone from a slaughtered animal carcass which has been split longitudinally, said apparatus comprising an elongated arm, fulcrum means at one end s of said arm for location against said carcass and engagement means intermediate the ends of said arm for engaging the pelvic bone adjacent the ischium thereof, whereby in use a force applied to the other end of said arm causes by a levering action about said fulcrum means, removal of said pelvic bone from said carcass.

2. Apparatus according to claim 1, wherein the elongated arm is of arcuate form along its length.

3. Apparatus according to claim 1 or claim 2, wherein the engagement means comprises means adapted for location within the obturator foramen of the pelvic bone to engage the ischium of the carcass.

4. Apparatus according to any one of the preceding claims, wherein the engagement means is in the form of a hook which is directed towards the other end of the arm

5. Apparatus according to any one of claims 2 to 4, wherein the engagement means is located on the convex side of the arm.

6. Apparatus according to claim 5, wherein the engagement means is suitably located within the plane or planes of the convexity of the arm.

7. Apparatus according to any one of the preceding claims, wherein the fulcrum means includes means to spread the load applied thereto when a force is applied to the other end of the arm to extract the pelvic bone.

8. Apparatus according to claim 7, wherein the means to spread the load is in the form of a fulcrum plate which lies in a plane extending transversely of the arm.

9. Apparatus according to claim 8, wherein the plate is angled acutely to the arm on the side of the arm containing the hook or other engagement means.

10. Apparatus according to claim 8 or claim 9, wherein the fulcrum plate is hingedly mounted to the arm for movement about an axis extending transversely of and suitably normal to the longitudinal axis of the arm.

11. Apparatus according to claim 10 and including biasing means to normally bias the plate to a position where it is juxtaposed with the arm on the side of the arm containing the engagement means.

12. Apparatus according to any one of the preceding claims wherein the other end of the arm includes gripping means to facilitate the application of a levering force to the arm, the gripping means comprising a handle which extends transversely of the arm

13. A method of removing the pelvic bone of the carcass of a slaughtered animal such as a beef cattle carcass which has been split longitudinally, said method including the steps of engaging the ischium of the pelvic bone through the obturator foramen of said pelvic bone with an intermediate portion of lever arm means and levering said pelvic bone from said carcass with said lever arm means.

14. A method according to claim 13, and including the step of engaging a fulcrum end of the lever arm means with the carcass to effect the levering action.

15. A method according to claim 13 or claim 14, wherein the levering of the pelvic bone is effected by application of a force to said lever arm means remote from the location of engagement of the ischium by the lever arm means in the manner of a second order lever.

16. Apparatus for removing the pelvic bone from a slaughtered animal carcass which has been split longitudinally substantially as hereinbefore described with reference to the accompanying drawings.
